(19) United States
(12) Patent Application Publication
(10) Pub. No.: US 2012/0171527 A1
(43) Pub. Date: Jul. 5, 2012

(54) BATTERY MODULE

(75) Inventor: Kazuto Hiroma, Sagamihara-shi (JP)

(73) Assignee: NEC ENERGY DEVICES, LTD., Sagamihara-shi, Kanagawa (JP)

(21) Appl. No.: 13/496,134

(22) PCT Filed: Oct. 15, 2009
(86) PCT No.: PCT/JP2009/005389

§ 371 Date: Mar. 14, 2012

(51) Int. Cl. H01M 2/10; H01M 2/00; H01M 10/48

(52) U.S. Cl. 429/61; 429/99; 429/90

(57) ABSTRACT

A battery module has following features, that are: a plurality of unit batteries, in which battery elements are sealed with a film casing material, is laminated and electrically connected in series or parallel, or in series and parallel, to make an assembled battery; and on a length-direction central portion of the assembled battery, at least one strip-shaped circular frame body is disposed.

### TECHNICAL FIELD

The present invention relates to a battery module in which a plurality of unit batteries is laminated and sealed with a film casing material.

### BACKGROUND ART

In recent years, as electronic devices, particularly portable information devices such as portable phones, laptop personal computers and camcorders, have made advances and become widespread, a small, lightweight secondary battery that is also high in energy density is used.

For the secondary battery that is high in energy density, a battery sealed with a film casing material instead of a conventional metallic casing material is put into use.

The battery sealed with a film casing material is high in energy efficiency per volume or weight. Therefore, the battery is suitable for use in the situation where a large current is required, such as power sources of an electric tool, electric bicycle or electric vehicle. Another feature of the battery is that it is easy to produce a battery module or battery pack, in which a plurality of unit batteries is stacked and electrically connected.

FIG. 5 is a perspective view illustrating a battery sealed with a film casing material.

As shown in FIG. 5, positive and negative electrodes are laminated via separators. Along with electrolyte, the battery is sealed with a film casing material. Positive-electrode tabs 21 and negative-electrode tabs 22 are pulled out before the film casing material is heat-sealed. A heat-sealing section 23 is formed on the periphery of a battery element, and a unit battery 20 is produced.

As for the unit battery 20 sealed with the film casing material, if a second battery such as a lithium ion secondary battery is used and troubles such as overcharge occur, the film casing material swells due to the pressure of gas generated inside the battery. Moreover, if troubles occur in a battery module in which a plurality of unit batteries is laminated and connected, the battery module becomes deformed and other problems arise.

In order to easily dissipate the gas generated inside a unit battery, what is proposed is to break the film casing material by providing a sharp projecting portion on an inner surface of a case in which the unit battery is stored. For example, see Patent Document 1.

Another proposal is to provide a projection having a through-hole on a case in which a battery module is stored and dissipate the generated gas to the outside of the case from the inside of the film casing material via the through-hole. For example, see Patent Document 2.

### CITATION LISTS

### Patent Documents

Patent Document 1: JP-A-10-208720

Patent Document 2: JP-A-2003-168410

### DISCLOSURE OF THE INVENTION

### Problems to be Solved by the Invention

In a battery module including an assembled battery in which a plurality of unit batteries sealed with a film casing material, is laminated and connected electrically in series or parallel, or in series and parallel, according to a method of providing a projecting portion on an inner surface of an exterior case, a battery having a projecting portion, which is designed to ensure the breakage of the film casing material at a time when a unit battery swells, is limited to the one adjacent to the projecting portion or a unit battery that the projecting shape is able to reach. Therefore, even if only the pressure of the unit battery that the projecting portion is able to reach is released, other unit batteries could keep swelling. In this case, because of the swelling of the unit batteries, it is difficult to reduce the possibility that the battery module would be deformed.

If the pressure of each unit battery in the battery module is not released and the unit batteries keep swelling, there is the possibility that a housing of the battery module is deformed as batteries swell, and that positive-electrode or negative-electrode tabs come in contact with each other and are short-circuited.

An object of the present invention is to provide a battery module that keeps positive-electrode and negative-electrode tabs from being in electrical contact with each other even when a unit battery sealed with a film casing material, is deformed due to an increase in pressure inside the unit battery.

### Means for Solving the Problems

To solve the above problems, in a battery module of the present invention, a plurality of unit batteries, in which battery elements are sealed with a film casing material, is laminated and electrically connected in series or parallel, or in series and parallel, to make an assembled battery; and on a length-direction central portion of the assembled battery, at least one strip-shaped circular frame body is disposed.

In the battery module, a positive-electrode-side input/output line is connected to a positive-electrode connection tab, which is joined to a positive-electrode end-portion tab of the assembled battery; a negative-electrode-side input/output line is connected to a negative-electrode connection tab, which is joined to a negative-electrode end-portion tab of the assembled battery; a battery voltage detection line is connected to a positive-electrode connection tab or a negative-electrode connection tab, positioned at both end portions of the assembled battery, and to an intermediate connection tab, which is joined to a joining section where positive-electrode and negative-electrode tabs of each unit battery are connected, before being taken out.

In the battery module, the battery voltage detection line is connected to a chip fuse, in which a plurality of electrically-independent fuses is formed on an insulating plate, before being taken out.

In the battery module, a positive-electrode active material of the unit batteries is lithium manganese composite oxide.

In the battery module, the strip-shaped circular frame body is made of a synthetic resin material, metallic material, or both of the synthetic resin material and metallic material.

The battery module includes insulating resin plates on upper and lower surfaces of a stacking plane of the assembled battery, wherein an insulating adhesive tape is attached to a side face.

### Advantages of the Invention

According to the present invention, in the event that unit batteries, which make up an assembled battery that makes up a battery module, swell, a strip-shaped circular frame body, which pushes the assembled battery in a laminating direction, is mounted. Therefore, when overcharge and other troubles occur, the swelling of the unit batteries is limited in the laminating direction even if the internal pressure inside the unit batteries sealed with a film casing material builds up. Thus, a heat-sealing section of the film casing material, which seals the unit batteries, a pressure release valve, which is mounted on the film casing material, or a breakable section, which is formed on the film casing material, cannot withstand an increase in internal pressure and breaks, releasing the pressure inside the battery.

As a result, the assembled battery inside the battery module does not swell dramatically. Therefore, it is possible to prevent the deformation of the battery module housings, which is attributable to the swelling of the assembled battery, and to eliminate the possibility that battery tabs are short-circuited as the battery tabs come in contact with each other.

Moreover, according to the present invention, only a strip-shaped circular frame body, which pushes the assembled battery in the laminating direction, is attached, and there is no need to change an assembling process drastically. In addition, with the use of conventional housings of the battery module, the present invention can be realized.

Furthermore, as for the battery module, it is unnecessary to take any particular measure to increase the strength of an exterior case against the swelling of the assembled battery.

### BRIEF DESCRIPTION OF THE DRAWINGS

FIG. 1 is an exploded perspective view illustrating a battery module according to an embodiment of the present invention.

FIG. 2 is a diagram illustrating the electric wiring of the battery module according to an embodiment of the present invention.

FIG. 3 is a diagram illustrating a battery module according to another embodiment of the present invention.

FIG. 4 is a perspective view illustrating a process of assembling an assembled battery.

FIG. 5 is an exploded perspective view illustrating how the assembled battery is electrically connected.

FIG. 6 is a perspective view illustrating a unit battery sealed with a film casing material according to an embodiment of the present invention.

FIG. 7 is a perspective view illustrating a unit battery sealed with a film casing material according to another embodiment of the present invention.

### BEST MODE FOR CARRYING OUT THE INVENTION

The following describes the present invention with reference to the accompanying drawings.

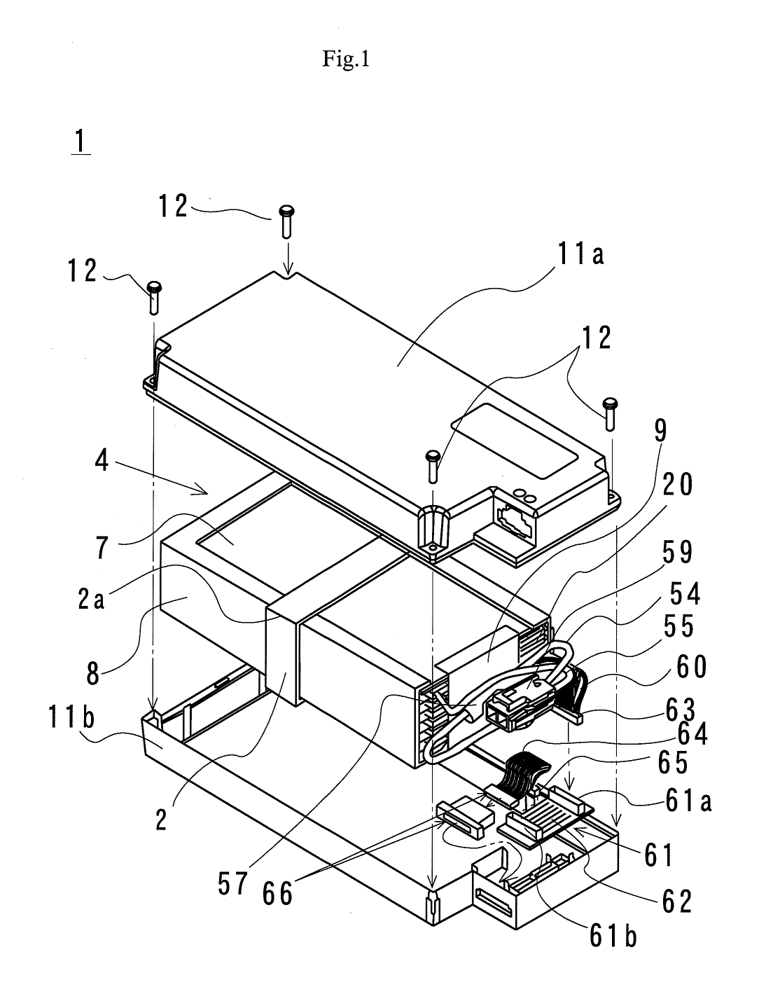

FIG. 1 is an exploded perspective view illustrating a battery module according to an embodiment of the present invention.

A battery module 1 includes an assembled battery 4, in which a plurality of unit batteries 20 is laminated, in housings 11a and 11b of the battery module. For the housings 11a and 11b of the battery module, the following materials can be used: synthetic resin, such as polycarbonate and ABS resin; metallic materials, such as aluminum, soft steel and stainless steel. The housings 11a and 11b of the battery module are coupled together with screws 12.

If a synthetic resin material is used as a member of the housings, it is possible to prevent a portion to which voltage is applied from being short-circuited when the portion comes in contact with the housings. Meanwhile, it is preferred that a metallic material be used if heat-release characteristics and strong housings are required.

In the battery module 1 illustrated in the example here, six unit batteries 20 are connected in series to make the assembled battery 4. The shape of unit batteries, the number of unit batteries connected, and the method of electrically connecting unit batteries may vary according to the way that the battery module 1 is used.

In the assembled battery 4, a battery protective plate 7, which is made of a synthetic resin material such as polycarbonate, is attached with a two-sided adhesive tape. On the periphery of a side face, adhesive tapes 8 and 9 are attached to insulate and fix the assembled battery 4.

Then, the assembled battery 4 is inserted into a frame of a strip-shaped circular frame body 2. The strip-shaped circular frame body 2 is positioned at a central portion of a length direction of the assembled battery. The assembled battery 4 is stored in the housings 11a and 11b and turned into the battery module 1.

For the circular frame body, the following may be used: a metallic circular body, which is made from nickel, stainless or other materials; a circular body, which is made by connecting strip-shaped metallic materials by means of resistance welding, laser welding, ultrasonic welding or other welding methods; or a body, which is made of nylon, polyethylene, polypropylene, fluorocarbon resin or other synthetic resin materials. A corner portion 2a of the strip-shaped circular frame body 2 may be formed in advance, so that the strip-shaped circular frame body 2 is easily mounted on the assembled battery.

The circular frame body does not necessarily adhere closely to the assembled battery. All that is required is for the circular frame body to be in close contact with the assembled battery at a time when the assembled battery swells slightly and play a role in curbing the further swelling of the assembled battery.

On the battery module 1, the following components are provided: a positive-electrode-side input/output line 54 of the assembled battery 4, a negative-electrode-side input/output line 55 of the assembled battery 4, and a battery voltage detection line 60, which is pulled out to monitor the voltage of each unit battery.

On the positive-electrode-side input/output line 54, a current fuse 57 for short-circuit protection is provided. On the battery voltage detection line 60, a chip fuse 61 for preventing a voltage detection line from being short-circuited is connected.

In that manner, the chip fuse, in which a plurality of fuses 62 are so formed as to be electrically independent on an insulating plate, is used. Therefore, it is easy to electrically connect a plurality of voltage detection lines. It is also possible to ensure that an assembling process is completed in a short period of time.

In the housings, the following connectors are provided: an input/output line external connection connector 59 and a battery voltage detection line external connection connector 66, which are connected to a device that uses the battery module, a battery pack or the like.

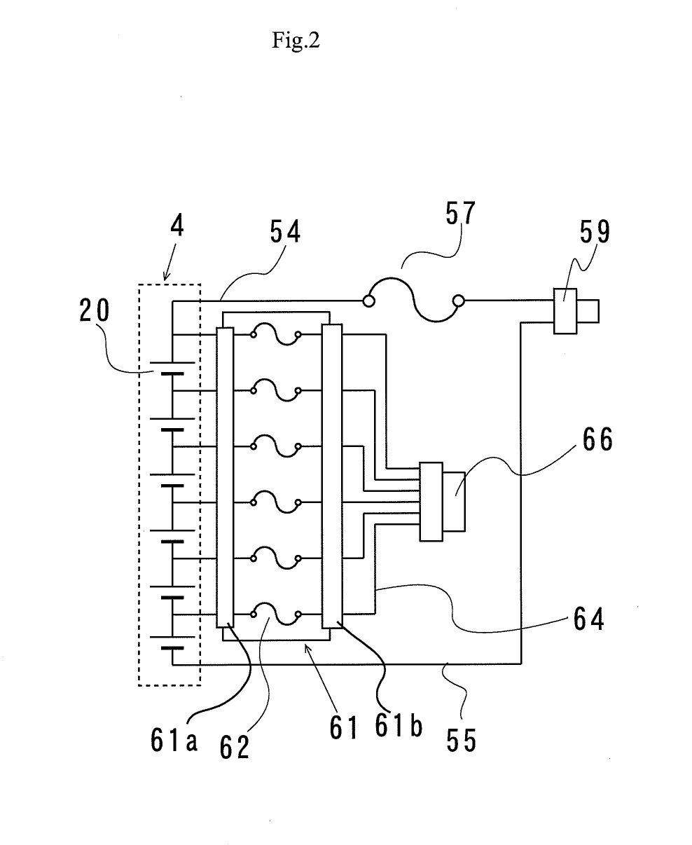

FIG. 2 is a diagram illustrating the electric wiring of the battery module according to an embodiment of the present invention.

In the example shown in FIG. 2, six unit batteries 20 are connected in series to make the assembled battery 4.

The following lines are connected: the positive-electrode-side input/output line 54, which is pulled out of a positive electrode of a unit battery positioned at one end of a laminated body of the assembled battery 4; and the negative-electrode-side input/output line 55, which is pulled out of a negative electrode of a unit battery positioned at the other end of the laminated body of the assembled battery. The positive-electrode-side input/output line 54 is connected to the input/output line external connection connector 59 via the current fuse 57, and to a battery protective circuit board.

Meanwhile, to a positive-electrode side of each unit battery, the battery voltage detection line 60 is connected. Six electrically-independent fuses 62 are connected via an input-side connector 61a of the chip fuse 61.

An output-side battery voltage detection line 64, which is connected to an output-side connector 61b of the chip fuse 61, is connected to the battery voltage detection line external connection connector 66, and to a battery protection circuit via the connector.

The number of unit batteries connected in series to form the assembled battery can be appropriately set according to the voltage and current required for a device that uses the battery. As for the voltage of a device that uses the battery, a 12V or 24V system can be listed among other things. However, for a lithium ion secondary battery, it is preferred that three or four unit batteries be connected in series for the 12V system, and six to eight for the 24V system. Moreover, it is possible to support various levels of voltage, such as 36V or 42V, by changing the number of unit batteries connected in series.

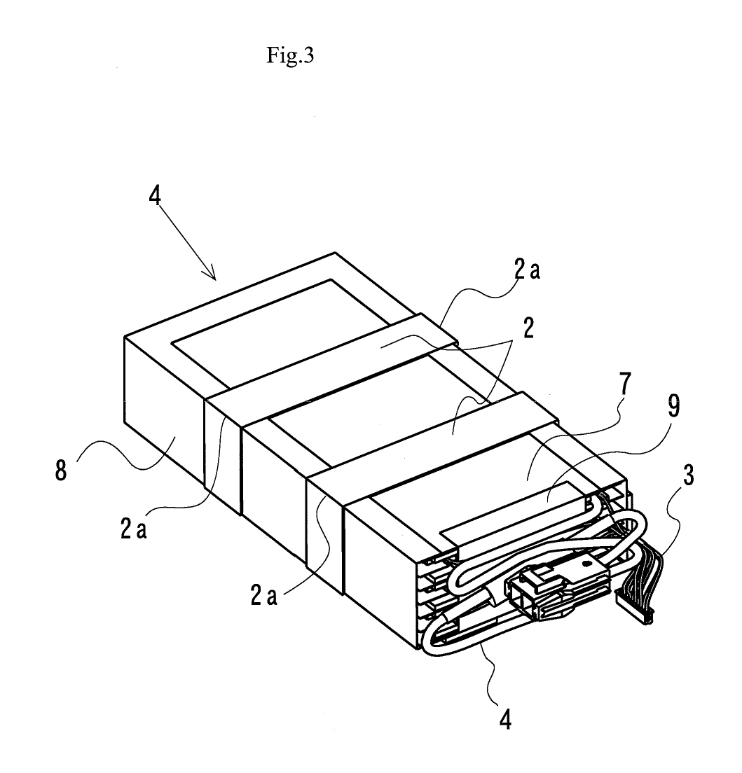

FIG. 3 is a diagram illustrating a battery module according to another embodiment of the present invention, and a diagram illustrating the battery module with housings removed.

In the battery module shown in FIG. 1, one strip-shaped circular frame body 2 is provided on the assembled battery 4 in such a way that the strip-shaped circular frame body 2 is positioned at a central portion in the length direction of the battery. On the other hand, in a battery module shown in FIG. 3, two strip-shaped circular frame bodies 2 are provided at a central portion so as to be spaced out.

In that manner, when two strip-shaped circular frame bodies are provided, it is possible to prevent the deformation of an even larger assembled battery even if the battery swells due to internal pressure. The number of strip-shaped circular frame bodies is not limited to two; any given number of strip-shaped circular frame bodies can be disposed according to the size of the battery.

Moreover, the above description uses an example in which the circular frame body is positioned at the central portion in the length direction of the unit battery. Since the circular frame body is disposed at the central portion in the length direction that can be significantly deformed as the internal pressure increases, it is possible to prevent the deformation of the battery module in an effective manner.

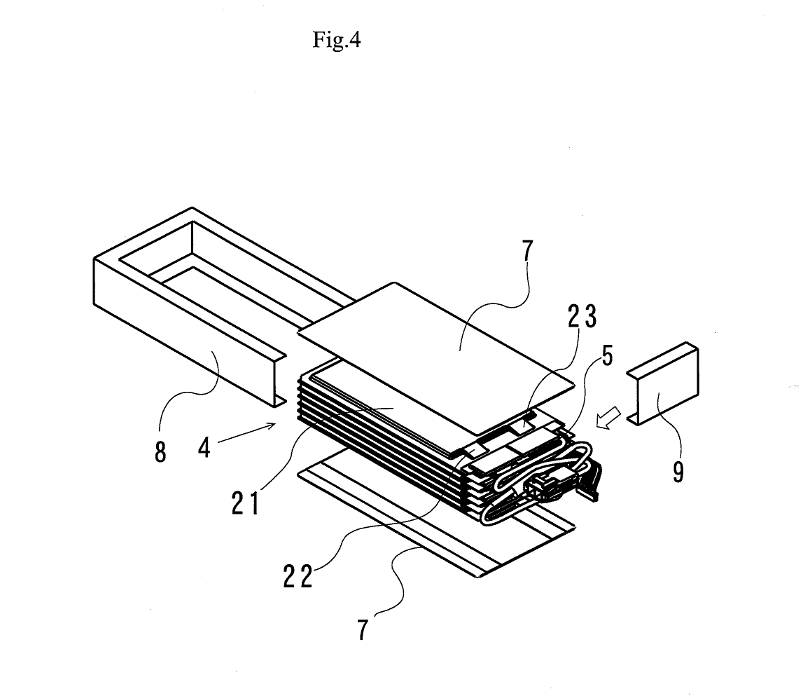

FIG. 4 is a perspective view illustrating a process of assembling the assembled battery.

A predetermined number of unit batteries 21 sealed with a film casing material, are laminated. After positive-electrode tabs 22 and negative-electrode tabs 23 are connected, insulating spacers 5, such as rubber sponge or other elastic materials, are disposed above and below the positive-electrode and negative-electrode tabs.

Then, on the top and bottom of the assembled battery 4 in which the unit batteries 21 are connected, battery protective plates 7, which are made of an insulating resin material such as polycarbonate, are attached with a two-sided adhesive tape. On the periphery of a side face, adhesive tapes 8 and 9 are attached to insulate and fix the assembled battery.

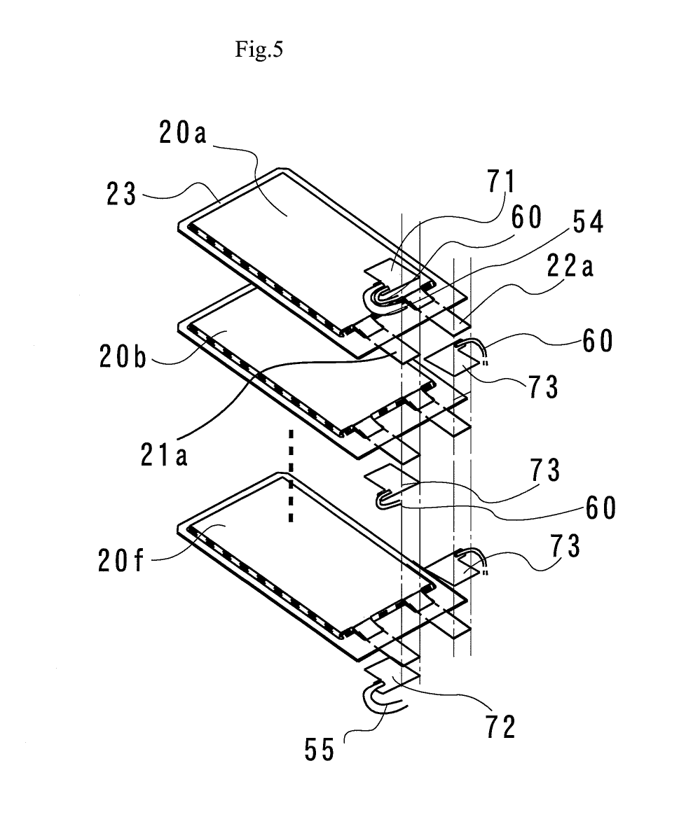

FIG. 5 is an exploded perspective view illustrating how the assembled battery is electrically connected.

FIG. 5 is a diagram illustrating the case where a predetermined number of unit batteries 21 sealed with a film casing material, is laminated and connected in series, and is a diagram illustrating the first and second layers from the top and the bottom layer with no intermediate layers shown in the diagram.

To a positive-electrode tab 21a of a top-layer unit battery 20a, a positive-electrode connection tab 71 is joined. To the positive-electrode connection tab 71, the positive-electrode-side input/output line 54 and the battery voltage detection line 60 are connected.

Between a negative-electrode tab 22a of the top-layer unit battery 20a and a positive-electrode tab 22b of the second layer, an intermediate connection tab 73 is disposed, and the three are joined together. To the intermediate connection tab, the battery voltage detection line 60 is connected.

To a negative-electrode tab 22f of a bottom-layer unit battery 20f, a negative-electrode connection tab 72 is connected. To the negative-electrode connection tab 72, the negative-electrode-side input/output line is connected.

In that manner, the positive-electrode-side input/output line 54 and the battery voltage detection line 60 are connected.

Between the negative-electrode tab 22a of the top-layer unit battery 20a and the positive-electrode tab 22b of the second layer, an intermediate connection tab 73 is disposed, and the three are joined together. To the intermediate connection tab, the battery voltage detection line 60 is connected.

To the negative-electrode tab 22f of the bottom-layer unit battery 20f, the negative-electrode connection tab 72 is joined. To the negative-electrode connection tab 72, the negative-electrode-side input/output line 55 is connected.

In that manner, it is preferred that: without soldering the positive-electrode-side input/output line 54 and the negative-electrode-side input/output line 55 to the positive-electrode and negative-electrode tabs of unit batteries, the positive-electrode-side input/output line 54 and the battery voltage detection line 60 be soldered to the positive-electrode connection tab 71, and the negative-electrode-side input/output line 55 to the negative-electrode connection tab 72; the positive-electrode connection tab 71 be then joined to the positive-electrode tab by means of resistance welding; the negative-electrode connection tab be similarly joined to the negative-electrode tab by means of resistance welding; after another battery voltage detection line 60 is soldered to the intermediate connection tab 73 in advance, the positive-electrode and negative-electrode tabs be placed at locations where the positive-electrode and negative-electrode tabs are joined; and the intermediate connection tabs and the positive-electrode and negative-electrode tabs be resistance-welded together.

In that manner, after the positive-electrode connection tab 71, the negative-electrode connection tab 72 and the intermediate connection tab 73 are soldered together, the positive-electrode tab or negative-electrode tab is welded. Therefore, it is possible to prevent the heat generated by soldering from having an adverse effect on the battery.

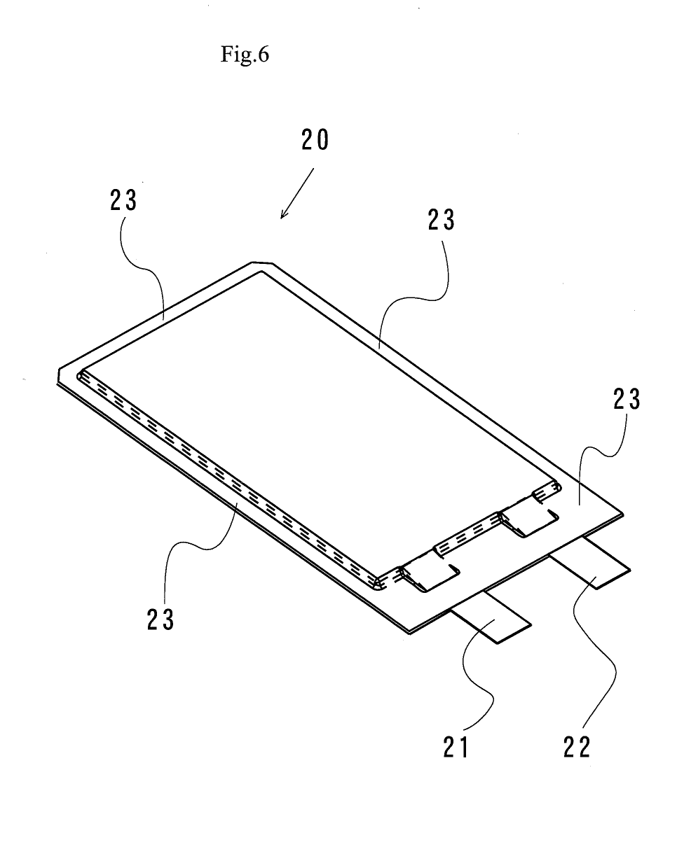

FIG. 6 is a perspective view illustrating a unit battery sealed with a film casing material according to an embodiment of the present invention.

The unit battery sealed with the film casing material is produced by laminating positive and negative electrodes and separators and sealing a battery element filled with an electrolytic solution with the film casing material.

In the example here, in a unit battery 20, a positive-electrode tab 21 and a negative-electrode tab 22 are pulled out from the same ridge of the unit battery. The unit battery 20 sealed with the film casing material, is sealed after a heat-sealing section 23 of the film casing material is formed on the periphery.

The positive-electrode and negative-electrode tabs are not limited to those pulled out from the same ridge as described above. The positive-electrode and negative-electrode tabs may be pulled out from an opposite side.

As for the unit battery, the positive electrode can be made by applying slurry, in which particles of a lithium transition metal composite oxide and carbonaceous conductivity adding materials such as carbon black are dispersed along with a binding agent, to a surface of a current collector made of aluminum foil.

For the lithium transition metal composite oxide, a lithium manganese composite oxide can be used. When the lithium manganese composite oxide is used, the battery, when being charged, is safer than those for which a lithium cobalt composite oxide is used. Therefore, it is possible to make the protection circuit of each unit battery simple. Thus, it is possible to make the battery modules smaller in size.

The lithium manganese composite oxide may be an oxide that includes only lithium and manganese, or a composite oxide including other chemical elements.

The negative electrode can be made by applying slurry to a surface of copper foil: the slurry is obtained by mixing graphite, amorphous carbon powder, silicon and the like, which are used to get lithium doped or undoped, along with a binding agent.

As for the film casing material, it is preferred to use a flexible stacked film that is made in the following manner: A polyethylene film having thermal adhesiveness is disposed on an inner surface of a unit battery; on an outer surface, strong polyethylene terephthalate, polyamide films or the like are disposed; and between the synthetic resin films of the inner and outer surfaces, aluminum foil is disposed and laminated.

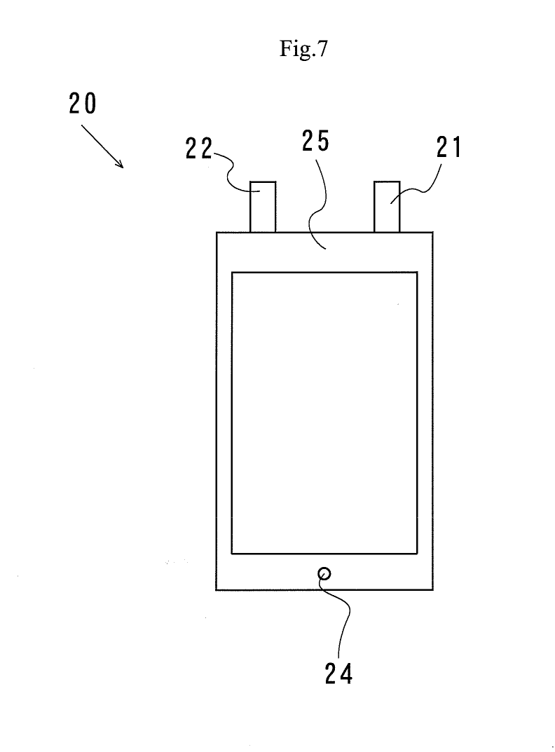

FIG. 7 is a perspective view illustrating a unit battery sealed with a film casing material according to another embodiment of the present invention.

A unit battery 20 shown in FIG. 7 includes a safety valve 24, which is positioned in a peripheral portion and is designed to be ripped open to release pressure as the pressure inside the battery builds up.

It is preferred that the safety valve 24 be provided at any peripheral portion other than an inter-terminal sealing section 25 between the positive-electrode tab 21 and the negative-electrode tab 22. When the safety valve 24 is provided in a sealing section that is positioned at an end portion of a length direction of the opposite side from the inter-terminal sealing section, it is possible to reduce the effects on a terminal at a time when the pressure increases, as well as to release the pressure immediately.

The safety valve 24 can be made by heat-sealing a film, which can rip open under lower pressure than the film casing material, on an area around an opening provided on the film casing material, or by cutting a notch, or making a thin-walled portion or the like, on the film casing material.

In that manner, what is provided is a portion that can rip open under lower pressure than a joining section made by the heat-sealing of the film casing material. A circular frame body is also provided on a unit battery. Therefore, it is possible to release the pressure in a safe manner without causing the deformation of a battery module at a time when the pressure inside builds up.

### EXAMPLES

The following describes the present invention using examples.

### Example 1

In a unit battery sealed with a film casing material, lithium manganate is used as a positive-electrode active material; graphite is used as a negative-electrode active material; and an electrolytic solution used is made by dissolving LiPF₆ in a mixed solvent of ethylene carbonate (EC) and diethyl carbonate (DEC). Positive-electrode and negative-electrode tabs are pulled out of the same ridge. The unit battery produced as described above is 158 mm in length, 82 mm in width and 5.6 mm in thickness.

On a positive-electrode tab of each unit battery, a negative-electrode tab is placed. In this manner, six unit batteries are laminated, with polycarbonate plates therebetween. The dimensions of the polycarbonate plates are 160 mm in length, 80 mm in width and 0.5 mm in thickness. The above components are bonded together with a two-sided adhesive tape.

Then, as shown in FIG. 2, which is a wiring diagram, to a positive-electrode tab of a unit battery that is positioned at one end, a positive-electrode-side connection tab, to which a positive-electrode-side input/output line 54 and battery voltage detection line 60 joined to a fuse are soldered, is resistance-welded. Moreover, between a negative-electrode tab of the unit battery and a positive-electrode tab of an adjoining unit battery, an intermediate connection tab, to which a battery voltage detection line is soldered, is disposed, and all the components are resistance-welded together.

Similarly, between the negative-electrode and positive-electrode tabs of the second to sixth unit batteries, intermediate connection tabs, to which battery voltage detection lines are soldered, are disposed, and all the components are resistance-welded together.

To the other end, which is a negative-electrode tab of the sixth unit battery, a negative-electrode-side connection tab, to which a negative-electrode-side input/output line is soldered, is resistance-welded.

Above and below the positive-electrode and negative-electrode tabs, a spacer, which is 20 mm in length, 30 mm in width and 2 mm in thickness and is made of rubber sponge, is bonded with a two-sided adhesive tape and insulated in such a way that each tab is not exposed.

To an upper and a lower surface of a stacking plane of the assembled battery, battery protective plates, which are 160 mm in length, 82 mm in width and 0.5 mm in height and made of polycarbonate, are attached with a two-sided adhesive tape. On the periphery of a side face of the assembled battery, adhesive tapes are attached to insulate and fix the assembled battery.

The assembled battery produced is 160.2 mm in length, 82.1 mm in width and 36.5 mm in thickness.

On a length-direction central portion of the assembled battery obtained, square circular bodies, which are made of a nickel plate that is 10 mm in width and 0.2 mm in thickness, are placed at two locations and spaced at an interval of 30 mm: the internal dimensions of the square circular bodies are 84 mm in width and 38.5 mm in length.

Then, the assembled battery is stored in housings made of polycarbonate. A connector of a battery voltage output line is connected to a connector of a chip fuse. Moreover, a connector of the chip fuse is connected to an external connection connector. Furthermore, a connector of a positive-electrode-side input/output line and a connector of a negative-electrode-side input/output line are attached. In this manner, a battery module is obtained.

### Example 2

In a similar way to that in Example 1, an assembled battery is produced. On a length-direction central portion of the assembled battery, a strip-shaped circular frame body, which is a circular nickel material that is 13 mm in width and 0.3 mm in thickness and is processed so as to have the following internal dimensions, is placed: 84 mm by 38.5 mm. After that, the assembled battery is stored in housings made of polycarbonate. In this manner, a battery module is obtained.

### Example 3

In a similar way to that in Example 1, an assembled battery is produced. Strip-shaped circular frame bodies, which are made by injection molding of polycarbonate so as to be 15 mm in width and 2 mm in thickness and have the internal dimensions 84 mm by 38.5 mm, are placed at two locations on a length-direction central portion of the assembled battery and are spaced at an interval of 30 mm. After that, the assembled battery is stored in housings made of polycarbonate. In this manner, a battery module is obtained.

### Comparative Example 1

In a similar way to that in Example 1, a unit battery is produced, and is stored in housings made of polycarbonate. In this manner, a battery module is obtained.

An overcharge test is conducted: a current of 44V and 7A is applied directly to the positive-electrode-side input/output lines of the battery modules of Examples 1 to 3 and Comparative Example, with no protective circuits therebetween. In Examples 1 to 3, the film casing materials and the heat-sealing sections break, releasing gas; the exterior cases are not deformed. In Comparative Example 1, the unit battery swells, resulting in the deformation of the housings.

### INDUSTRIAL APPLICABILITY

According to the present invention, in the event that an assembled battery, which is made up of a laminated body of unit batteries that make up a battery module, swells, a strip-shaped circular frame body, which pushes the assembled battery in a laminating direction, is mounted on a length-direction central portion of the assembled battery. Therefore, when overcharge and other troubles occur, the swelling of the assembled battery is limited in the laminating direction even if the internal pressure inside the unit batteries whose openings are sealed with a film casing material builds up. Thus, a heat-sealing section of the film casing material, which seals the openings of the unit batteries, a pressure release valve, which is mounted on the film casing material, or a breakable section, which is formed on the film casing material, cannot withstand an increase in internal pressure and breaks, releasing the pressure inside the battery. As a result, it is unnecessary to take any particular measure to increase the strength of housings against the swelling of the unit batteries.

### Explanation of Reference Symbols

1: Battery module

2: Strip-shaped circular frame body

2a: Corner portion of circular frame body

4: Assembled battery

5: Insulating spacer

7: Battery protective plate

8, 9: Adhesive tape

11a, 11b: Housing

12: Screw

20: Unit battery

21: Positive-electrode tab

22: Negative-electrode tab

23: Heat-sealing section

24: Safety valve

25: Inter-terminal sealing section

54: Positive-electrode-side input/output line

55: Negative-electrode-side input/output line

57: Current fuse

59: Input/output line external connection connector

60: Battery voltage detection line

61: Chip fuse

62: Fuse

64: Output-side battery voltage detection line

66: Voltage detection line external connection connector

71: Positive-electrode connection tab

72: Negative-electrode connection tab

73: Intermediate connection tab

1. A battery module, characterized in that:
a plurality of unit batteries, in which battery elements are sealed with a film casing material, is laminated and electrically connected in series or parallel, or in series and parallel, to make an assembled battery; and on a length-direction central portion of the assembled battery, at least one strip-shaped circular frame body is disposed.

2. The battery module according to claim 1, characterized in that:
a positive-electrode-side input/output line is connected to a positive-electrode connection tab, which is joined to a positive-electrode end-portion tab of the assembled battery; a negative-electrode-side input/output line is connected to a negative-electrode connection tab, which is joined to a negative-electrode end-portion tab of the assembled battery; a battery voltage detection line is connected to a positive-electrode connection tab or a negative-electrode connection tab, positioned at both end portions of the assembled battery, and to an intermediate connection tab, which is joined to a joining section where positive-electrode and negative-electrode tabs of each unit battery are connected, before being taken out.

3. The battery module according to claim 1 or 2, characterized in that
the battery voltage detection line is connected to a chip fuse, in which a plurality of electrically-independent fuses is formed on an insulating plate, before being taken out.

4. The battery module according to any one of claims 1 to 3, characterized in that
a positive-electrode active material of the unit batteries is lithium manganese composite oxide.

5. The battery module according to any one of claims 1 to 4, characterized in that
the strip-shaped circular frame body is made of a synthetic resin material, metallic material, or both of the synthetic resin material and metallic material.

6. The battery module according to any one of claims 1 to 5, characterized by comprising
insulating resin plates on upper and lower surfaces of a stacking plane of the assembled battery, and an insulating adhesive tape is attached to a side face.
